(19) United States
(12) Patent Application Publication
(10) Pub. No.: US 2024/0028228 A1
(43) Pub. Date: Jan. 25, 2024

(54) TIERED MEMORY DATA STRUCTURES AND ALGORITHMS FOR STATIC SEARCHING VIA BINARY SEARCH

(71) Applicant: VMware, Inc., Palo Alto, CA (US)

(72) Inventors: Siddhartha Visveswara Jayanti, Boston, MA (US); Marcos Kawazoe Aguilera, Mountain View, CA (US); Naama Ben David, Mountain View, CA (US)

(21) Appl. No.: 17/868,621

(22) Filed: Jul. 19, 2022

(51) Int. Cl. G06F 3/06

(52) U.S. Cl. CPC G06F 3/064; G06F 3/0604; G06F 3/0673

(57) ABSTRACT

In one set of embodiments, a computer system can receive an input array including n elements and sort the input array to generate a sorted array including the n elements in ascending or descending element order. The computer system can further convert the sorted array into a tree-ordered array including the n elements in a tree order, where the tree order corresponds to a descending order of nodes in a binary tree created from the n elements. The computer system can then place the first m<n elements of the tree-ordered array in first memory tier of the computer system and place the remaining n−m elements of the tree ordered array in a second memory tier of the computer system, where the second memory tier has a slower access time than the first memory tier.

### BACKGROUND

Unless otherwise indicated, the subject matter described in this section is not prior art to the claims of the present application and is not admitted as being prior art by inclusion in this section.

Modern computer systems use a tiered memory architecture that comprises a hierarchy of different memory types, referred to as memory tiers, with varying cost and performance characteristics. For example, the highest byte-addressable memory tier of this hierarchy typically consists of dynamic random-access memory (DRAM) modules, which are fairly expensive but provide fast access times. The lower memory tiers of the hierarchy include slower but cheaper (or at least more cost efficient) memory types such as byte-addressable persistent memory, remote memory, and so on.

Because of the differences in performance across memory tiers, it is desirable for applications to place more frequently accessed data in higher (i.e., faster) tiers and less frequently accessed data in lower (i.e., slower) tiers. Unfortunately, many data structures and algorithms that are commonly employed by applications today, particularly in the problem domain of searching, are not designed with tiered memory in mind. Accordingly, these existing data structures and algorithms fail to adhere to the foregoing rule, resulting in suboptimal performance.

### BRIEF DESCRIPTION OF THE DRAWINGS

FIG. 1 depicts an example tiered memory system.

FIGS. 2A and 2B depict the creation of an example sorted array and the execution of a binary search operation on a binary tree representation of the sorted array.

FIG. 3 depicts the sorted array and binary search operation from FIGS. 2A and 2B in the scenario where the first half of the sorted array is placed in fast memory and the second half of the sorted array is placed in slow memory.

FIG. 4 depicts a flowchart of a tiered memory static search algorithm according to certain embodiments.

FIG. 5 depicts the outcome of applying the algorithm of FIG. 4 to the sorted array and binary search operation of FIGS. 2A and 2B according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to data structures and algorithms that may be implemented by a tiered memory system for efficiently performing static searching via binary search. Generally speaking, these data structures and algorithms (referred to herein as “tiered memory” data structures/algorithms) ensure that most of the memory accesses needed to carry out the static search task are directed to data maintained in higher (i.e., faster) memory tier(s) and conversely very few memory accesses are directed to data maintained in lower (i.e., slower) memory tier(s). This results in improved performance over standard static search algorithms that assume a single tier of memory.

### 1. Example Tiered Memory System and Problem Statement

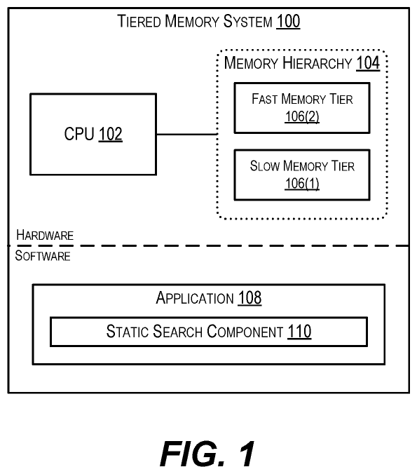

FIG. 1 is a simplified block diagram of an example tiered memory system 100 in which the techniques of the present disclosure may be implemented. As shown, tiered memory system 100 includes in hardware a CPU 102 that is coupled with a memory hierarchy 104. Memory hierarchy 104 is a logical collection of memory tiers that are ordered from highest to lowest. Each memory tier represents a different type of physical memory present in tiered memory system 100, with higher memory tiers consisting of faster but more expensive (and thus scarcer) memory and lower memory tiers consisting of slower but cheaper (and thus more abundant) memory.

For simplicity, memory hierarchy 104 is depicted as including exactly two memory tiers: a “fast” memory tier 106(2) having an associated size (i.e., capacity) m and cost per memory access c, and a “slow” memory tier 106(1) having an associated size M>m and cost per memory access C>c. For example, fast memory tier 106(2) may comprise DRAM, which offers fast memory access times on the order of tens of nanoseconds but is typically limited in size to several hundred gigabytes. In contrast, slow memory tier 106(1) may comprise persistent memory (also known as non-volatile RAM or NVRAM), which offers slower memory access times on the order of hundreds of nanoseconds but can feasibly reach capacities of several terabytes or more. In alternative embodiments, memory hierarchy 104 may include any number of further memory tiers beyond two.

In addition to CPU 102 and memory hierarchy 104, tiered memory system 100 includes in software an application 108 comprising a static search component 110. Static search component 110 is tasked with solving the static search problem, which is commonly encountered in computing contexts such information retrieval, combinatorial optimization, and so on. Stated formally, this problem pertains to the implementation of a static data structure S that supports the following functions:
1. S←Preprocess(A): create and return S with the elements in an input array A.
2. S.Search(x): return true iff x ∈ S.

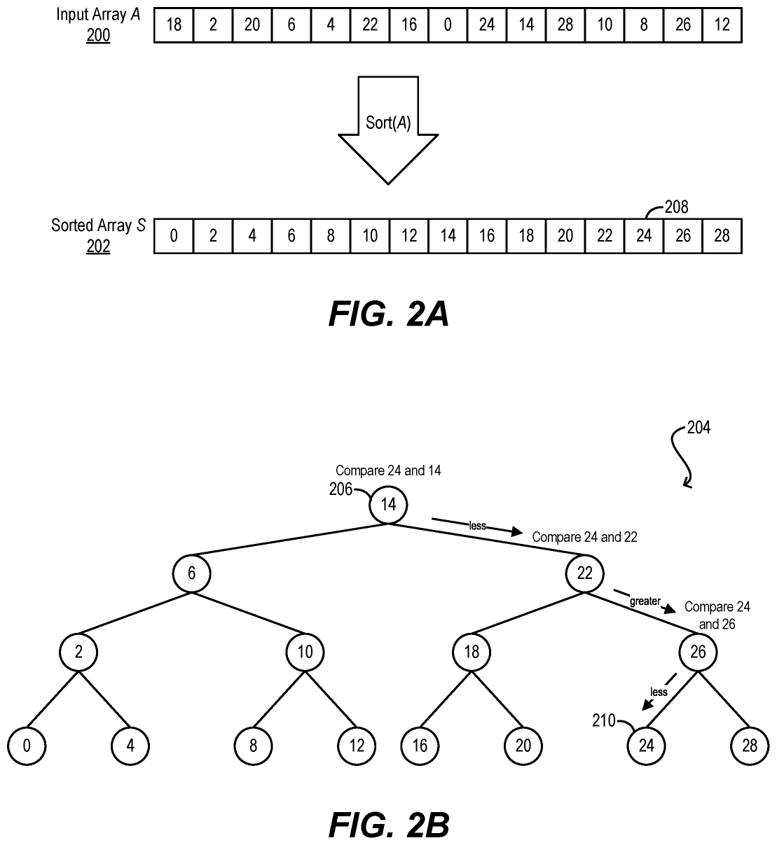

The standard algorithm for solving the static search problem efficiently using a single tier of memory involves (1) implementing Preprocess (A) by creating and storing a sorted version of array A (i.e., sorted array S←Sort(A)) in the single memory tier, where the elements in S are sorted in ascending order, and (2) implementing Search(x) by binary-searching for query element x within sorted array S. For example, FIG. 2A illustrates step (1) (i.e., the creation of sorted array S (reference numeral 202) from input array A (reference numeral 200)) and FIG. 2B illustrates step (2) (i.e., a binary search for query element “24” on sorted array S via a binary tree representation 204 of S). As shown in FIG. 2B, the binary search process begins by comparing query element “24” with median element “14” in sorted array S (which is the root node 206 of binary tree representation 204) and eliminating the left half of the array (i.e., the left sub-tree below root node 206) because “24” is greater than “14.” Note that if the query element were less than the median element, the right half of the array (i.e., the right sub-tree below root node 206) would be eliminated instead. The foregoing steps are then repeated recursively on the un-eliminated sub-array/sub-tree until the query element matches the median element (in which case the query element is found and Search(x) returns true) or there are no more sub-arrays/sub-trees to traverse (in which case the query element is not found and Search(x) returns false). For example, in FIG. 2B, “24” is ultimately found at array element 208 corresponding to tree node 210. This overall approach has a time complexity of Θ(n log n) for the pre-processing sort and Θ(log n) for the binary search.

If the size of array A or S (denoted herein as n) is less than or equal to the size of fast memory tier 106(2) of tiered memory system 100 (i.e., m), static search component 110 can simply leverage the standard algorithm above using fast memory tier 106(2) and thereby implement static searching in a time-optimal manner. In other words, static search component 110 can operate as if system 100 consists of a single memory tier corresponding to fast tier 106(2) and can perform all memory accesses required by Preprocess(A) and Search(x) against that tier, resulting in a total time complexity of Θ(cn log n)+Θ(c log n).

However, for purposes of the present disclosure, it is assumed that n is greater than the size of fast memory tier 106(2) (i.e., m) and less than the size of slow memory tier 106(1) (i.e., M)), with a constant (or super-constant) excess factor

$$α {=}^{Δ} \frac{n}{m}$$

indicating the proportion of the data size to the fast memory tier size. As a result, static search component 110 is constrained by that fact that it cannot fit the entirety of array A or S within fast memory tier 106(2); instead, as part of executing Preprocess(A) and Search(x), component 110 must place at least some constant fraction of the data in slow memory tier 106(1). The question raised by this setting (and answered by the present disclosure) is therefore the following: how can static search component 110 arrange/manipulate the data for the static search problem across fast and slow memory tiers 106(2) and 106(1) to best take advantage of the faster speed of fast memory tier 106(2) and thus accelerate the search process? Or stated another way, how can static search component 110 arrange/manipulate the data for the static search problem across fast and slow memory tiers 106(2) and 106(1) to achieve a speed up over simply implementing the standard algorithm entirely in slow memory tier 106(1) (which has a total time complexity of Θ(Cn log n)+Θ(C log n))?

### 2. Solution Overview

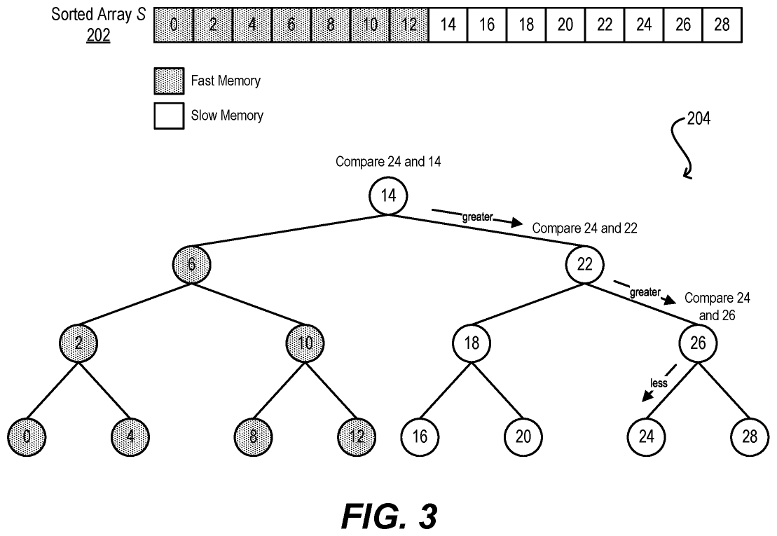

One approach that initially seems sensible is to revise the standard algorithm such that the first m elements of the array being processed (i.e., input array A or sorted array S) are placed in fast memory tier 106(2)—thereby fitting as much of the array into fast memory as possible—and the remaining n−m elements are placed in slow memory tier 106(1). Unfortunately, while this approach appears promising at first blush, in the worst case static search component 110 will still need to access slow memory tier 106(1) log n times in order to execute Search(x) This can be seen in FIG. 3, which illustrates a scenario in which the first half of sorted array S from FIGS. 2A and 2B is able to fit in fast memory tier 106(2), but because the binary search for query element “24”requires accessing elements that all appear in the latter half of S (and thus reside on slow memory tier 106(1)), all log n memory accesses for the search operation are performed against the slow tier. As a result, the algorithm's time complexity is Θ(Cn log n)+cm log m)=Θ(Cn log n) for pre-processing and Θ(C log n+c log m)=Θ(C log n) for search, which means that the entire complexity of the algorithm is limited by slow memory tier 106(1) and thus there is no speed up from using fast memory tier 106(2).

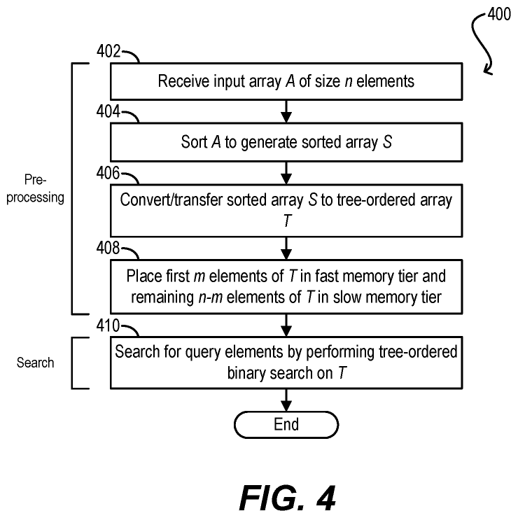

A better solution, which is the focus of the embodiments disclosed herein, is illustrated at a high level in the form of flowchart 400 of FIG. 4. Starting with steps 402 and 404, static search component 110 can receive a request to preprocess an input array A of size n elements in order to enable static searching of those n elements and can sort A to generate a sorted array S, where the elements of S are sorted in ascending (or descending) element order.

At step 406, static search component 110 can convert sorted array A into a tree-ordered array T, such that the elements in T are sorted according to a node order of the binary tree representation of S that is used by Search(x) for performing binary-searching, rather than in an element order. In a particular embodiment, the elements in tree-ordered array T may be sorted in a descending node order, such that the first element of T is the root node of the binary tree representation of S, the second element of T is the left child node of the root node, the third element of T is the right child node of the root node, and so on.

Once tree-ordered array T is created, static search component 110 can place (i.e., store) the first m elements of T in fast memory tier 106(2) and place the remaining n−m elements of T in slow memory tier 106(1) (step 408). This effectively places the m highest (i.e., closest to root) nodes in the binary tree representation of S in the fast memory tier.

Finally, at step 410, static search component 110 can search for query elements by performing a tree-ordered binary search on tree-ordered array T (or in other words, a binary search that takes into account the tree ordering of elements in T).

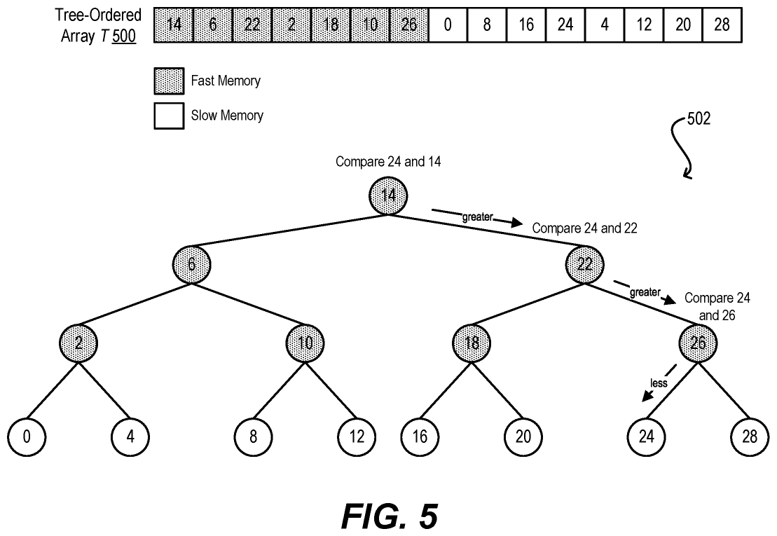

To explain the intuition behind this high-level solution, FIG. 5 illustrates a tree-ordered array T (reference numeral 500) that may be created from sorted array S of FIGS. 2A and 2B per step 406 of flowchart 400, where the first half of T is placed in fast memory tier 106(2) and the second half of T is placed in slow memory tier 106(1). In addition, FIG. 5 illustrates a binary tree representation of T (reference numeral 502) that is used for performing tree-ordered binary-searching on T per step 410 of flowchart 400. This binary tree is identical to binary tree 204 of FIGS. 2B and 3.

As can be seen in FIG. 5, the first two levels of binary tree representation 502 are in fast memory tier 106(2) and only the last (i.e., bottom) level of binary tree representation 502 is in slow memory tier 106(1). This is highly advantageous because in any binary search operation, the search will start from the root node of the binary tree and traverse down a tree “spine” towards the leaf nodes. This means that most memory accesses will occur with respect to elements high up in the tree (i.e., near the root), and exponentially fewer memory accesses will occur for elements deeper down in the tree (i.e., near the leaves). Accordingly, by converting sorted array A into a tree-ordered array T and placing the first m elements of T in fast memory tier 106(2), static search component 110 can ensure that every invocation of Search(x) will perform most of its memory accesses in fast memory, resulting in a speed up over the standard algorithm.

In particular, if elements [1, . . . , m] of tree-ordered array T are stored in fast memory tier 106(2) and elements [m+1, . . . , n] of T are stored in slow memory tier 106(1), every root-to-leaf traversal will take at most

$$O ( C log \frac{n}{m} + c log m ) = O ( C log α + c log m ) time ,$$

which is significantly faster than standard binary search. The mathematical reason for this speed up is that the number of memory accesses in slow memory tier 106(1) is just logarithmic in the excess factor a rather than in the size of the entire array (i.e., n). For example, in scenarios where n=m polylog(m) (which will be common in practice), the algorithm of flowchart 400 will only perform O(log log n) memory accesses in slow memory tier 106(1), which is exponentially smaller than O(log n). In the specific case shown in FIG. 5 where n=2m, the algorithm of flowchart 400 will only perform, at most, a single memory access in slow memory tier 106(1).

The remaining sections of this disclosure provide additional details for implementing the solution of FIG. 4, including efficient algorithms for generating sorted array S from input array A and for converting S into tree-ordered array T in the presence of fast and slow memory tiers 106(2) and 106(1). It should be appreciated that FIGS. 1-5 are illustrative and not intended to limit embodiments of the present disclosure. For example, although static search component 110 is shown as being implemented in software as part of application 108, in some embodiments the static search techniques of the present disclosure may be implemented in hardware via a circuit such as a field-programmable gate array (FPGA) or an application-specific integrated circuit (ASIC). Further, although FIG. 1 depicts a particular arrangement of components within tiered memory system 100, other arrangements are possible (e.g., the functionality attributed to a particular component may be split into multiple components, components may be combined, etc.). Yet further, tiered memory system 100 may include other components or subcomponents that are not specifically described. One of ordinary skill in the art will recognize other variations, modifications, and alternatives.

### 3. Sorting

Standard sorting algorithms such as heap sort, merge sort, quicksort, and the like may be used by static search component 110 of tiered memory system 100 to sort the elements of input array A and create sorted array S per step 404 of flowchart 400. However, because these standard sorting algorithms are not designed with tiered memory in mind, they may end up performing all of their operations in slow memory tier 106(1), leading to Θ(Cn log n) complexity. The following subsections describe two tiered memory sorting algorithms that static search component 110 may use instead to achieve better sorting performance than the standard algorithms.

### 3.1 Tiered Memory Heap Sort

As known in the art, a binary heap data structure is a complete binary tree of d levels that is represented by a linear array of 2^{d-1} elements. Each element of the array corresponds to a node of the binary tree and the parent-child relationships within the tree are implicitly defined by the elements' positions (i.e., indexes) in the array. In other words, this array is tree-ordered, such that the index of each element in the array reflects that element's node location in the binary tree.

In one set of embodiments, static search component 110 can leverage these properties to implement a novel tiered memory heap sort algorithm that involves (1) building a binary heap using the n elements of input array A, (2) allocating the first m elements of the binary heap in fast memory tier 106(2), (3) allocating the remaining n−m elements of the binary heap in slow memory tier 106(1), and (4) executing the standard heap sort algorithm on the binary heap as allocated across memory tiers 106(2) and 106(1) via (2) and (3). Assuming static search component 110 simply inserts all of the elements into the binary heap and performs the standard delete-min operation on the binary heap n times in order to extract the elements in sorted order, the time complexity of this algorithm is O(Cn log α+cn log m).

### 3.2 Tiered Memory Merge Sort

An m-way merge sort is a sorting algorithm that splits an input array into m sub-arrays and recursively applies the split operation to each sub-array until the original array is divided into “sorted” sub-arrays of size 1 (i.e., a single element). The algorithm then repeatedly merges together sorted sub-arrays, resulting in larger sorted sub-arrays, until a final sorted sub-array is produced. This final sorted sub-array is the sorted version of the original input array.

In one set of embodiments, static search component 110 can implement a novel tiered memory m-way merge sort algorithm for sorting input array A that uses fast memory tier 106(2) as a cache during each merge operation, resulting in improved performance over standard merge sort. This algorithm assumes that, at the time of merging m individually sorted sub-arrays A₁, . . . , Aₘ, all of the sub-arrays are stored on slow memory tier 106(1) and fast memory tier 106(2) is empty and ready to be used.

Initially, static search component 110 can build a min binary heap Q on fast memory tier 106(2) with elements A₁[0], . . . , Aₘ[0] of the m sorted sub-arrays. Static search component 110 can then sort the elements of binary heap Q into a new sorted sub-array B stored on slow memory tier 106(1) in steps, where each step (1) inserts Q.deleteMin( ) to the sorted part of B, and (2) if the newly inserted element was Aⱼ[i], performs Q.insert(Aⱼ[i+1]). Finally, static search component 110 can repeat the foregoing on subsequent groups of elements of A₁, . . . , Aₘ (e.g., A₁[1], . . . , Aₘ[1], then A₁[2], . . . , Aₘ[2], etc.) all while making sure that at most one element from each Aᵢ is maintained in fast memory tier 106(2) (via binary heap Q) at a time.

With the merge process above, two principles can be observed: (1) each element in ∪_{i∈[m]} Aᵢ is moved from slow memory tier 106(1) to fast memory tier 106(2) exactly once and is moved back exactly once, and (2) each element addition and removal from fast memory tier 106(2) takes O(c log m) time. This leads to an overall time complexity for the tiered memory m-way merge sort of O(Cn logₘn+cn log n), which is faster than the tiered memory heap sort described previously.

### 4. Tree Ordering

### 4.1 For Complete Binary Trees

In cases where sorted array S generated at step 404 of flowchart 400 has exactly n=2^{d+1}−1 elements for some non-negative integer d, the elements of S can form a complete binary tree of node-depth d with 2^{d}−1 internal nodes and 2^{d} leaf nodes. In these embodiments, it is possible to efficiently convert (or in other words, transfer) sorted array S into a tree-ordered array T per step 406 of flowchart 400 by simply applying a bit reversal function p to the binary representation of the index of each element in S. Although the mathematical proof of this is beyond the scope of the present disclosure, the output of ρ—which effectively reverses the bits in the binary representation (i.e., converts a bit string b_{d-1}b_{d-2} . . . b₀ into b₀b₁ . . . b_{d-1})—will correspond to the correct index (in binary) for that element in tree-ordered array T, assuming both S and T are “one-indexed” (i.e., each array starts at index number 1 rather than 0). If S and T are implemented as standard zero-indexed arrays, the correct index for T can be derived from a given index i of S as ρ(i+1)−1.

Bit reversals can be computed in a single instruction on modern CPU architectures. Accordingly, using this approach, tree-ordered array T can be created with a time complexity of O(Cn).

### 4.2 For Arbitrary Values of n

In cases where the size n of sorted array S does not conform to 2^{d+1}−1 for some non-negative integer d, the bit reversal approach above will not work correctly. To address this, Listing 1 below presents pseudo-code for a novel Srt-to-Tree(S) procedure (along with an associated helper function StoT( )) that takes as input sorted array S and returns a tree-ordered array T with the elements of S for arbitrary values of n. The high-level idea behind this algorithm is to perform root-to-leaf (i.e., spine) traversals on all possible paths in the binary tree representation of sorted array S in a recursive breadth-first-search (BFS) manner and to write out the elements encountered during these BFS traversals to tree-ordered array T. In alternative embodiments, a different traversal order (such as depth-first-search (DFS)) may be employed.

Listing 1

| | Procedure Srt-to-Tree(S) |
|---|---|
| 1: | n ← S.len |
| 2: | T ← new array[0,...,n] |
| 3: | StoT(S,T,0,1,0,n) |
| 4: | return T |
| | Procedure StoT(S,T,t,d,s₀,s₁) |
| 1: | if s₁ <= s₀ then return |
| 2: | s ← s₀ + min ((s₁−s₀)/2) |
| 3: | T[t] ← S[s] |
| 4: | StoT(S,T,t+d,2d,s₀,s) |
| 5: | StoT(S,T,t+2d,2d,s+1,s₁) |

As shown, Srt-to-Tree( ) first creates a new array T (line 2) of the same length as input array S (line 2) and calls function StoT( ) (line 3), which fills in each component of T with the correct value from S. Array T is finally returned at line 4.

The function StoT( ) transfers values from a sub-array S[s₀, . . . , s₁] to their correct locations in array T via recursion (note that in alternative embodiments, a loop-based mechanism can be used instead). Specifically, a call to this function specifies, along with S and T, a current position t in the array T, a value d=2^{δ} where δ is the current depth of the recursion, and the lower (inclusive) and upper (exclusive) limits of the sub-array s₀ and s₁. If the sub-array is empty, the function returns immediately (line 5). Otherwise, it calculates the index of the median element of the sub-array (line 6), stores the corresponding element S[s] in T [t] (line 7), and makes recursive calls to process the sub-arrays S[s₀, . . . , s] and S[sₛ₊₁, . . . , s₁]. There are d entries between the t^{th} element and its left child and 2d entries between the t^{th} element and its right child because a binary tree has 2⁶⁷ nodes at each depth δ; thus, the current position for the left sub-tree recursion and the right sub-tree recursion are specified accordingly (lines 8 and 9). And the highest level of recursion specifies that the full array S needs to be transferred to T and the root of the binary tree should be placed at position t=0 (line 3).

### 5. Tree-Ordered Binary Search

Listing 2 below presents pseudo-code for a novel Search(T, x) procedure and associated function Binary-Search( ) that may be implemented by static search component 110 to perform tree-ordered binary-searching for a query element x on tree-ordered array T (per step 410 of flowchart) according to certain embodiments.

Listing 2

| | Procedure Search(T,x) |
|---|---|
| 1: | return Binary-Search(T,x,0,1,0,T.len) |
| | Procedure Binary-Search(T,x,t,d,s₀,s₁) |
| 1: | len ← s₁ − s₀ |
| 2: | if s₁ <= s₀ then return −1 |
| 3: | s ← s₀ + min ((s₁−s₀)/2) |
| 4: | if T[t] = x then return s |
| 5: | else if T[t] = x then return Binary-Search(T,x,t+d,2d,s₀,s) |
| 6: | else return Binary-Search(S,T,t+2d,2d,s+1,s₁) |

Generally speaking, this algorithm recursively performs a root-to-leaf traversal on the binary tree representation of tree-ordered array T to find an element T[t] that equals query element x. If T[t]=x is found, the algorithm returns the rank of that element, which is the number of other elements in T that are less that T[t] in sorted element order (line 4).

If T[t]=x is not found, the algorithm recurses down either the left or right sub-tree (but not both). In particular, if T[t]>x the algorithm recurses down the left sub-tree (line 5); otherwise if T[t]<x the algorithm recurses down the right sub-tree (line 6). As with the Srt-to-Tree( ) procedure discussed previously, the use of recursion here is not required and other functionally-equivalent mechanisms such as loops may be employed.

### 6. Final Static Search Algorithm

With the foregoing descriptions of tiered memory merge sort and the algorithms for creating tree-ordered array T from sorted array S and performing tree-ordered binary search in mind, Listing 3 below presents pseudo-code for the final tiered memory solution to the static search problem according to certain embodiments.

Listing 3

| | Procedure S ← Preprocess(A) |
|---|---|
| 1: | S ← Merge-Sort(A) |
| 2: | T ← Srt-to-Tree(S) |
| | Procedure S.Search(x) |
| 1: | return Binary-Search (T,x,0,1,0,T.len) |

The time complexity of Preprocess( ) above is O(Cn logₘn+cn log n) and the time complexity of Search( ) is

$$O ( C log \frac{n}{m} + c log m ) .$$

The space complexity of the overall algorithm is (m, n−m) for the fast and slow memory tiers respectively.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by computer system including first and second memory tiers, a request to preprocess an input array including n elements to enable static searching of the n elements, wherein the second memory tier has a slower memory access time than the first memory tier, wherein the n elements are greater in size than the first memory tier, and wherein preprocessing the input array comprises determining a placement of the n elements across the first and second memory tiers;
sorting, by the computer system, the input array to generate a sorted array including the n elements in ascending or descending element order;
converting, by the computer system, the sorted array into a tree-ordered array including the n elements in a tree order, the tree order corresponding to a descending order of nodes in a binary tree created from the n elements;
placing, by the computer system, a first m elements of the tree-ordered array in the first memory tier of the computer system, wherein m is less than n; and
placing, by the computer system, a remaining n−m elements of the tree ordered array in the second memory tier of the computer system.

2. The method of claim 1 further comprising:
receiving a request to search for presence of a query element in the n elements; and
performing a tree-ordered binary search for the query element on the tree-ordered array, wherein the tree-ordered binary search causes the computer system to perform fewer memory accesses to the second memory tier than to the first memory tier because of the storing of the first m elements of the tree-ordered array in the first memory tier.

3. The method of claim 1 wherein the sorting comprising:
building a binary heap that includes the n elements;
placing a first m elements of the binary heap in the first memory tier;
placing a remaining n−m elements of the binary heap in the second memory tier; and
sorting the binary heap using a heap sort algorithm.

4. The method of claim 1 wherein the sorting is performed via a merge sort algorithm that uses the first memory tier as a cache during each merge operation.

5. The method of claim 1 wherein n=2^{d+1}−1 for some non-negative integer d, and wherein the converting comprises, for each element of the sorted array:
determining a binary representation of an index of the element; and
performing a bit reversal of the binary representation to determine a corresponding index for the element in the tree-ordered array.

6. The method of claim 1 wherein n≠2^{d+1}−1 for some non-negative integer d, and wherein the converting comprises:
performing traversals on all possible root-to-leaf paths in a binary tree representation of the sorted array; and
writing elements encountered during the traversals to the tree-ordered array.

7. The method of claim 1 wherein m equals a size of the first memory tier and wherein n is less than a size of the second memory tier.

8. A non-transitory computer readable storage medium having stored thereon program code executable by a computer system including first and second memory tiers, the program code embodying a method comprising:
receiving a request to preprocess an input array including n elements to enable static searching of the n elements, wherein the second memory tier has a slower memory access time than the first memory tier, wherein the n elements are greater in size than first memory tier, and wherein preprocessing the input array comprises determining a placement of the n elements across the first and second memory tiers;
sorting the input array to generate a sorted array including the n elements in ascending or descending element order;
converting the sorted array into a tree-ordered array including the n elements in a tree order, the tree order corresponding to a descending order of nodes in a binary tree created from the n elements;
placing a first m elements of the tree-ordered array in the first memory tier of the computer system, wherein m is less than n; and
placing a remaining n−m elements of the tree ordered array in the second memory tier of the computer system.

9. The non-transitory computer readable storage medium of claim 8 wherein the method further comprises:
receiving a request to search for presence of a query element in the n elements; and
performing a tree-ordered binary search for the query element on the tree-ordered array, wherein the tree-ordered binary search causes the computer system to perform fewer memory accesses to the second memory tier than to the first memory tier because of the storing of the first m elements of the tree-ordered array in the first memory tier.

10. The non-transitory computer readable storage medium of claim 8 wherein the sorting comprising:
building a binary heap that includes the n elements;
placing a first m elements of the binary heap in the first memory tier;
placing a remaining n−m elements of the binary heap in the second memory tier; and
sorting the binary heap using a heap sort algorithm.

11. The non-transitory computer readable storage medium of claim 8 wherein the sorting is performed via a merge sort algorithm that uses the first memory tier as a cache during each merge operation.

12. The non-transitory computer readable storage medium of claim 8 wherein n=2^{d+1}−1 for some non-negative integer d, and wherein the converting comprises, for each element of the sorted array:
determining a binary representation of an index of the element; and
performing a bit reversal of the binary representation to determine a corresponding index for the element in the tree-ordered array.

13. The non-transitory computer readable storage medium of claim 8 wherein n≠2^{d+1}−1 for some non-negative integer d, and wherein the converting comprises:
performing traversals on all possible root-to-leaf paths in a binary tree representation of the sorted array; and
writing elements encountered during the traversals to the tree-ordered array.

14. The non-transitory computer readable storage medium of claim 8 wherein m equals a size of the first memory tier and wherein n is less than a size of the second memory tier.

15. A computer system comprising:
a processor;
a first memory tier;
a second memory tier having a slower memory access time than the first memory tier; and
a non-transitory computer readable medium having stored thereon program code that causes the processor to:
receive a request to preprocess an input array including n elements to enable static searching of the n elements, wherein the n elements are greater in size than first memory tier, and wherein preprocessing the input array comprises determining a placement of the n elements across the first and second memory tiers;
sort the input array to generate a sorted array including the n elements in ascending or descending element order;
convert the sorted array into a tree-ordered array including the n elements in a tree order, the tree order corresponding to a descending order of nodes in a binary tree created from the n elements;
place a first m elements of the tree-ordered array in the first memory tier, wherein m is less than n; and
place a remaining n−m elements of the tree ordered array in the second memory tier.

16. The computer system of claim 15 wherein the program code further causes the processor to:
receive a request to search for presence of a query element in the n elements; and
perform a tree-ordered binary search for the query element on the tree-ordered array, wherein the tree-ordered binary search causes the processor to perform fewer memory accesses to the second memory tier than to the first memory tier because of the storing of the first m elements of the tree-ordered array in the first memory tier.

17. The computer system of claim 15 wherein the program code that causes the processor to sort the input array comprises program code that causes the processor to:
build a binary heap that includes the n elements;
place a first m elements of the binary heap in the first memory tier;
place a remaining n−m elements of the binary heap in the second memory tier; and
sort the binary heap using a heap sort algorithm.

18. The computer system of claim 15 wherein the sorting is performed via a merge sort algorithm that uses the first memory tier as a cache during each merge operation.

19. The computer system of claim 15 wherein n=2^{d+1}−1 for some non-negative integer d, and wherein the program code that causes the processor to convert the sorted array comprises program code that causes the processor to, for each element of the sorted array:
determine a binary representation of an index of the element; and
perform a bit reversal of the binary representation to determine a corresponding index for the element in the tree-ordered array.

20. The computer system of claim 15 wherein n≠2^{d+1}−1 for some non-negative integer d, and wherein the program code that causes the processor to convert the sorted array comprises program code that causes the processor to:
perform traversals on all possible root-to-leaf paths in a binary tree representation of the sorted array; and
write elements encountered during the traversals to the tree-ordered array.

21. The computer system of claim 15 wherein m equals a size of the first memory tier and wherein n is less than a size of the second memory tier.
